(19) United States
(12) Patent Application Publication
(10) Pub. No.: US 2008/0105283 A1
(43) Pub. Date: May 8, 2008

(54) Clear-coated high pressure hose

(75) Inventors: John Pianetto, Hoffman Estates, IL (US); Gus Alexander, Inverness, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: FAIP North America, Inc., Elk Grove Village, IL (US)

(21) Appl. No.: 11/593,259

(22) Filed: Nov. 2, 2006

(51) Int. Cl. B08B 13/00; F16L 11/00

(52) U.S. Cl. 134/198; 138/125; 29/592

(57) ABSTRACT

The invention provides an abrasion-resistant high pressure hose with an inner core comprising a flexible material; a flexible reinforcing sheath covering the core that has a grid of interwoven strands of reinforcing fiber material; and a clear-coated jacket covering the sheath with an optically transparent or translucent polymeric material such that the reinforcing sheath is visible though the jacket to a user from the outside of the hose. The invention also provides a method of manufacturing a clear-coated abrasion resistant hose. The invention also provides a high pressure washing apparatus with a clear-coated abrasion resistant hose.

### BACKGROUND OF THE INVENTION

The invention is in the field of pressure washing equipment, and relates specifically to hoses for high-pressure pressure washers.

The prior art has provided pressure washers for use in washing surfaces such as wood, tile, concrete and the like. A pressure washer typically comprises a source of a pressurized washing fluid and an operator wand connected with a high-pressure hose. The prior art further has provided numerous hoses for use in conjunction with such pressure washers, which hoses typically comprise a jacketed core of thermoplastic material or other opaque material. Such conventional pressure washer hoses are capable of accommodating the moderately high pressures associated with conventional power washers while leaving a satisfactory margin of safety.

Hoses designed for use in consumer applications must be sufficiently flexible to accommodate the demands of consumer pressure washers. Recently, U.S. Pat. No. 5,964,409, which is hereby incorporated by reference in its entirety, disclosed satisfactory flexible thermoplastic pressure-washer hoses that are designed to operate at high pressures with the safety margin conventionally required.

The prior art has further provided numerous high-pressure hoses for use in applications other than pressure washers, such as industrial fire protection hoses and chemically resistant hoses for industrial equipment. Typically, such a hose comprises an inner tube covered with a reinforcing braided sheath, which, in turn, is covered by an outer jacket. Known consumer grade high-pressure hoses typically are made of very stiff materials to accommodate the high pressures expected under operating conditions, and little or no thought typically is paid to the flexibility of the hose. As a result, such hoses generally are unsuitable for use with consumer pressure washer applications, which mandate that the hose be highly flexible. Moreover, many such hoses tend to kink if bent past an angle of about 90° over a short distance, which kinking is disruptive of the flow of pressurized fluid through the hose and potentially detrimental to the hose and to the equipment serviced by the hose.

There exists a continuing need among consumer users to have a high pressure hose for pressure washers that is adapted for more reliable operation. Users need to be able to more reliably inspect the internal condition of high pressure hoses in order to note potential breakage in reinforcement layers prior to the existence of a dangerous condition. Users need high pressure hoses that are increasingly abrasion resistant and which lend themselves to economical manufacture and usage.

### BRIEF SUMMARY OF THE INVENTION

It is an object of the invention to meets user needs by providing a hose with a clear-coated jacket sufficient to allow user inspection of the hose interior, a reinforcing sheath in said interior that can be coated or dyed to impart distinctive color, while maintaining said coated jacket with sufficient abrasion resistance in consumer use.

Accordingly, the invention provides an abrasion-resistant high pressure hose comprising:

(a) an inner core comprising a flexible material and defining a fluid-carrying conduit;

(b) a flexible reinforcing sheath covering said core, said sheath comprising a grid of interwoven strands of reinforcing fiber material disposed in surrounding relation to said core; and

(c) a clear-coated jacket covering said sheath, said jacket comprising an optically transparent or translucent polymeric material disposed in surrounding relation to said sheath such that the reinforcing sheath is visible though the jacket to a user from the outside of the hose.

The invention also provides a method of manufacturing a clear-coated abrasion-resistant high pressure hose comprising the steps of obtaining strands of reinforcing fiber material, contacting said strands with at least one at least one coating material sufficient to impart a distinctive color, extruding a flexible material to form an inner core with an inner and outer surface, disposing an adhesive onto the outer surface of said core, braiding said strands into an interwoven grid surrounding said core to form a sheathed core, and applying a clear-coated jacket comprising an optically transparent or translucent polymeric material to form said clear-coated abrasion-resistant high pressure hose such that the reinforcing sheath is visible though the jacket to a user from the outside of the hose.

The invention also provides a pressure washing apparatus comprising a source of pressurized water; an operator wand; and a clear-coated abrasion-resistant hose fluidically connecting said operating wand to said source, said hose comprising an inner core comprising a flexible material and defining a fluid-carrying conduit; a flexible reinforcing sheath covering said core, said sheath comprising a grid of interwoven strands of reinforcing fiber material disposed in surrounding relation to said core; a clear-coated jacket covering said sheath, said jacket comprising an optically transparent or translucent polymeric material disposed in surrounding relation to said sheath such that the reinforcing sheath is visible though the jacket to a user from the outside of the hose.

### BRIEF DESCRIPTION OF THE SEVERAL VIEWS OF THE DRAWING(S)

FIG. 1 is a diagrammatic depiction of an illustrative pressure washer having a flexible high-pressure hose in accordance with the invention;

FIG. 2 is an enlarged side elevation view, partially cut away, of the high-pressure hose of the pressure washer shown in FIG. 1;

FIG. 3 is an enlarged cross-section taken in the plane of line 3-3 in FIG. 2; and

FIG. 4 is a view of the hose shown in FIG. 2 when the hose is bent through an angle of 180°.

While the invention is susceptible of various modifications and alternative constructions, certain illustrated embodiments thereof has been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention.

### DETAILED DESCRIPTION OF THE INVENTION

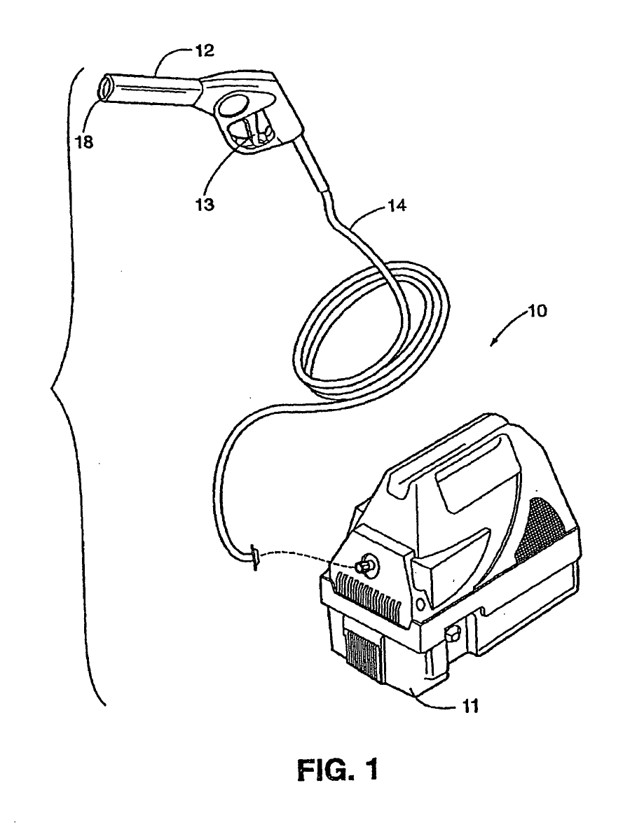

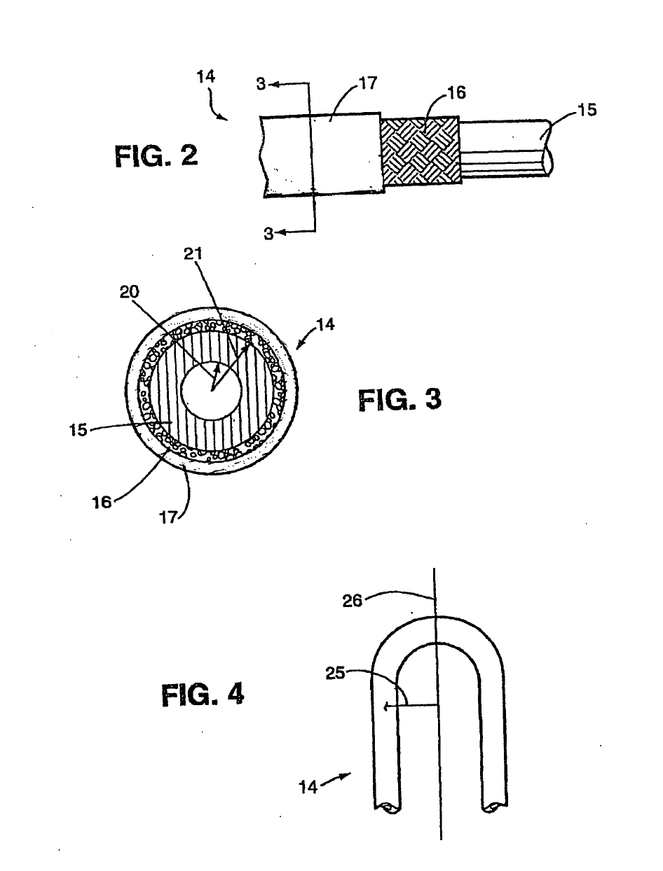

Referring now to FIG. 1, the pressure washer of the invention, shown generally at 10, is of generally conventional configuration and comprises a pump 11 fluidically connected to an operator wand 12 via a high-pressure fluid transfer hose 14. The fluid used in the pressure-washer typically is water, optionally mixed with a washing fluid such as a liquid soap. Fluid is fed from the pump 11, which typically is connected to a water line for generation of a continuous stream of pressurized water. Upon leaving the pump 11, the pressurized cleaning fluid travels through the hose 14 to the operator wand 12. The operator wand 12 typically includes a nozzle 18 and trigger valve 13 for allowing an operator to controllably direct a stream of the pressurized fluid towards a substrate for washing. The hose, wand, and fluid source each may be provided with conventional fittings and couplings to effect appropriate fluid-tight connections therebetween. The hose 14, as depicted in FIG. 2, in this instance is of concentric laminar construction, and includes a central core 15, a reinforcing sheath 16, and a clear-coated outer jacket 17.

In keeping with the invention, the core 15 is composed of a flexible material, which is preferably a thermoplastic polymeric material and which is capable of accommodating cleaning fluid of pressures of at least about 1000 psi while maintaining a high degree of flexibility when fluid is not in the hose. Materials suitable for use in conjunction with the core are numerous, and include, for example, high tensile strength thermoplastic elastomers such as those of the SANTOPRENE family of thermoplastic rubbers. The SANTOPRENE elastomers having a tensile strength of at least about 14 MPa and a tear strength of at least about 40 kN/m at 25° C. Other suitable materials include reinforced polypropylene and nylons, such as nylon-6 and nylon-6, 6. One suitable polyethylene is a linear low-density polyethylene sold by Dow with a density of 0.92 g/cc. The polypropylene or nylon or other material may be reinforced with rubber, carbon black, or other suitable materials.

The invention is not limited to the foregoing thermoplastic elastomers, and indeed any material having suitable flexibility and strength and resistance to the intended fluid can be used in conjunction with the invention. The material preferably is a thermoplastic material that is extrudable, i.e., amenable to extrusion to form the core of a high pressure hose. For example, other materials suitable for use in formulating the core include rigid polymers, such as polyvinylchloride and copolymers of polyvinylchloride with other suitable polymers, which rigid polymers are conventionally employed in less flexible high-pressure hoses. To render such materials sufficiently flexible for use in conjunction with pressure-washing applications, the rigid polymer is blended with a plasticizer in an amount effective to impart sufficient flexibility to the rigid polymer such that the finished hose has the flexibility desired. When formulating a core material, the rigid polymer is preferably present in the core material in an amount ranging from about 40% to about 60% by weight, and the plasticizer is preferably present in an amount ranging from about 20% to about 40% by weight. The core may include other materials, such as stabilizers, modifiers, and other ingredients as would be within the ordinary skill in the art.

When the core is constructed of materials such as polyvinylchloride or strong thermoplastic elastomers, it will be capable of accommodating hot pressurized aqueous washing fluids, and most preferably water. For pressure washer applications, the hose generally need not be able to accommodate oil-based fluids. In preferred embodiments of the invention, the hose will be able to accommodate washing fluids with temperatures of at least about 100° F., more preferably, at least about 120° F., and most preferably at least about 140° F.

The core preferably has an annular cross section that defines a fluid-carrying conduit within the core, the core having sufficient dimensions to accommodate the high-pressure washing fluid. In preferred embodiments of the invention, the inner radius 20 of the annular core, as shown in FIG. 3, ranges from about 3.2 to about 3.3 mm, and the outer radius 21 ranges from about 4.7 to about 4.8 mm. In other embodiments, the inner radius of the inner core ranges from about 4.1 to 4.2 mm and the outer radius ranges from about 5.4 to about 5.5 mm. While the hose may be provided with a corrugated core (not shown), the core preferably is non-corrugated, and thus has a substantially uniform annular cross section.

With further reference to FIGS. 2 and 3, to increase the burst resistance of the hose, the hose is provided with a flexible reinforcing sheath 16, which covers and preferably is adhesively secured to the core 15. The sheath preferably is of a braided construction, and thus preferably comprises interwoven strands of a reinforcing fibrous material. The reinforcing fibrous material is polymeric or metallic or a combination thereof.

In one embodiment of the invention, when the reinforcing fibrous material comprises a metallic material, the metallic material preferably is an anodized a high carbon steel fiber. One preferred steel fiber is sold by Bekaert as a 0.25 mm diameter fiber having a tensile strength in the range from 2750-3050 N/mm² and a breaking strength of 142 N. Other fibers are contemplated to be useful in conjunction with the invention; for instance, other steel fibers having diameters ranging from 0.20 mm to 0.56 mm, a tensile strength in the range from 2150 to 3350 N/mm², and a breaking strength of 91-565 N are sold by Bekaert and are deemed useful in conjunction with the invention. Other metallic fibers contemplated to be useful in conjunction with the invention include other metallic fibers of high tensile strength and breaking strength, such as titanium fibers. The tensile strength of the fibers preferably should exceed about 2150 N/mm² and the breaking strength of the fibers preferably should exceed 90 N.

In another embodiment of the invention, when the reinforcing fibrous material is polymeric, any suitable polymeric braiding material with sufficient strength may be used, including polyester filament yarns. Preferably, the polymeric material is a high-tenacity polyester filament yarn having a breaking strength ranging from about 85 N to about 100 N. One typical polymeric material is polyester yarn sold under the trademark DIOLEN 183.

In another embodiment, when the reinforcing fibrous material is a combination of polymeric and metallic materials, the materials are typically applied in any order. Preferably the materials are layered, and more preferably the inner layer comprises a polymeric material with the outer layer comprising a metallic material. When a combination of materials is used in the reinforcing later, multiple braiding steps are typically used.

Generally speaking, the braided sheath and the manner in which the braided sheath is applied over the core are conventional. Many conventional hoses are reinforced with a braided sheath that has a braid angle of about 1.40 or less. To minimize bulk and material and maintain maximum flexibility of the reinforcing layer, the braided sheath of the hose of the invention preferably is braided at an angle of at least about 1.41, more preferably a braid angle ranging from about 1.41 to about 1.48. Any suitable number of braids per strand and, more generally, any suitable braiding conditions may be employed. It has been found that braiding the sheath with a metallic sheathing fiber at such higher braid angles than are conventionally employed will lend a higher burst strength to the hose, and yet will maintain sufficient hose flexibility to allow for use in consumer pressure washing applications and other high pressure applications. The sheathing preferably has a thickness ranging from about 1.0 to about 1.3 mm on a round fiber. If desired, the hose may be provided with a double sheathing layer, although such may detract from the flexibility of the hose.

The braided sheath is preferably adhesively secured to the core layer with a compatible adhesive, which preferably comprises a urethane or acrylate adhesive. One suitable adhesive comprises a mixture of polyurethane and methyl ethyl ketone. The adhesive may be included in any amount sufficient to impart adhesion between the core and sheath, preferably an adhesive strength sufficient to prevent separation of the core from the sheath when the hose is bent.

In accordance with an important aspect of the invention, the hose has a clear-coated jacket layer 17 comprising an optically-transparent or translucent polymeric material such that the reinforcing sheath is visible through the jacket to a user from outside the hose. By virtue of the optically-transparent or translucent cover, a consumer user can visually see that the hose is reinforced and can more readily observe potential defects before, during, or after usage, in order to ensure safe operation and avoid potentially dangerous conditions. Preferably the optically transparent or translucent polymeric material is selected from the group consisting of polyurethane, polyvinyl chloride (also known as PVC), polyester, and combinations thereof. More preferably, it is a blend of polyurethane and polyvinyl chloride. The optically transparent or translucent material may be optionally blended with an added ingredient as protection against UV effects. The material may also be optionally blended with any commercially available dye to color the clear-coated jacket a distinctive color such as red, blue, yellow, gray, or black. Such dyes for polymeric materials are typically widely available to those of skill in the art.

In further carrying out the invention, alternatively the reinforcing sheath 16 may be made of a distinctive color, which can be viewed through the transparent or translucent jacket 17, for imparting a distinctive color to the hose. Such colors can be coordinated with the color of the clear-coated jacket (if any) and/or the color of other components of a pressure-washing apparatus 10. Generally, a transparent hose may be equivalent to a clear hose, while a translucent hose may be equivalent to a colored hose. Importantly for both transparent and translucent embodiments, the reinforcing sheath 16 is clear-coated to be visible to the user from the outside of the hose.

The clear-coated jacket 17 preferably has a thickness of about 1.0 to about 1.2 mm. The jacket preferably is adhesively secured to the braided sheath with sufficient adhesive to impart adhesion between the jacket and the sheath, preferably sufficient to provide an adhesive strength sufficient to prevent separation between the jacket and sheath when the hose is bent. The adhesive is preferably similar or identical to that used to adhesively connect the sheath and core. The hose preferably is a “non-cooked” hose; that is, it is preferably made by extruding the core, applying adhesive and the sheathing layers (after first contacting the sheathing material with a coating as needed), and applying further adhesive and the jacket layer without thermally bonding the layers together.

In keeping with the invention, the transparent or translucent materials of the clear-coated jacket 17 are abrasion resistant to further protect the hose from damage or wear during usage and handling. The clear-coated jacket 17 also prevents damage to the braided layer and thus renders the entire hose highly resistant to abrasion during use.

In accordance with another embodiment of the invention, a method of manufacturing a clear-coated abrasion-resistant high pressure hose comprises the following steps, which may be performed in any logical sequence. A flexible material is extruded, preferably through an annular die, to form an inner core 15 for the hose that has an inside surface for carrying fluid and an outside surface for additional layers. The manufacturer also obtains strands of reinforcing fiber material, optionally contacting said strands with at least one at least one coating material sufficient to impart a distinctive color. The manufacturer then places an adhesive onto the outer surface of said core and proceeds to braiding the obtained strands into an interwoven grid surrounding the core in order to form a sheathed core with a flexible reinforcing sheath 16. The final and most important step comprises application of a clear-coated jacket 17 comprising an optically transparent or translucent polymeric material to form the clear-coated hose, which has a visible reinforcing sheath 16 though the jacket 17 from the outside of the hose.

As stated, in an embodiment where the manufacturer contacts the reinforcing fiber material with a coating material prior to braiding the sheath 16 and applying it over the core 15, the reinforcing fibrous material is optionally dyed with at least one coating material sufficient to impart a distinctive color, that is of course if the fiber does not already have a desired distinctive color. Some distinctive colors include red, blue, yellow, gray, black or any other color. Preferably the color can be selected so as to be coordinated with the pressure washing apparatus 10 and selected as suitably compatible to the clear-coated jacket 17 described above.

In an embodiment where the reinforcing fibrous material is metallic, the metallic material is preferably contacted with at least one coating material. Such a coating material can stabilize the metallic material against rust. Such a coating can also provide a visually aesthetic appearance for inspection by the consumer through the clear-coated jacket described below. A preferred coating material comprises copper or brass, and especially is brass when the underlying metallic material comprises steel.

In further keeping with the invention, the hose has preferably has a minimum bend radius no greater than about 10 times the radius of the hose, and preferably in the range from 6.5 to 8.25 times the radius of the hose. The minimum bend radius may be determined by bending the hose with no fluid contained therein over an angle of 180° and by reducing the size of the bend to as small a diameter as possible without kinking the hose, as shown, for example, in FIG. 4. The minimum bend radius 25 of the hose 14 may be defined as the distance between the central bend line 26 of the bent portion of the hose and the center of the hose, the distance being measured along an angle normal to the bend line 26. By incorporating a flexible material in the core of the hose of the present invention, a high-pressure hose having a minimum bend radius no greater than about 38 mm while maintaining the ability to accommodate high pressures may be provided. In preferred embodiments, the invention provides a hose that is sized such that the hose has a minimum bend radius no greater than about 36 mm. More preferably, the minimum bend radius is no greater than about 34 mm, and even more preferably, the minimum bend radius is no greater than about 32 mm. The high-pressure hose of the invention will thus be sufficiently flexible for use in consumer pressure washing applications and other high-pressure applications. The minimum bend radius may be, for instance, between 6.5 and 8.5 times the radius of the hose.

The hose preferably has burst rating sufficiently below its burst pressure to leave a 300% margin of safety between the rated pressure and the burst pressure. The burst pressure of the hose is the gauge pressure that the hose will accommodate before bursting. Thus, for example, a hose with a hose rating of 300 psi will have a burst pressure of at least about 900 psi, it being understood that the hose will accommodate pressures of at least 1000 psi, and possibly much higher pressures, before bursting. Preferably, the hose of the invention has a burst pressure of at least about 4,000 psi. More preferably, the hose has a burst pressure of at least about 8,000 psi, even more preferably, the burst pressure is at least about 14,000 psi.

To ensure the structural integrity of the hose, the hose should have a minimum impulse value of at least about 10,000 cycles, more preferably, at least about 20,000 cycles, and most preferably, at least about 30,000 cycles. The impulse value is conventionally defined and refers to the number of cycles for which the hose may be pressurized to its hose rating (i.e., 25% of the burst pressure) and reduced to zero gauge pressure before failure of the hose, each pressurization and depressurization constituting one cycle. The impulse test and equipment for conducting the impulse test are well known in the art.

Preferably, the hose of the invention is substantially non-deforming, such that the dimensions of the hose do not change when the pressure washer is operated at its rated pressure (i.e., 25% of the burst pressure). In preferred embodiments, the hose of the invention preferably has an elongation at its rated pressure of no more than about 5%, and preferably no more than about 3%. Most preferably, the volumetric expansion of the hose at the rated pressure preferably is no more than about 4.0 cc/ft., more preferably, no more than about 3.8 cc/ft., and most preferably, no more than about 3.5 cc/ft.

The hose finds particular applicability in commercial pressure washers. Other applications, such as hydraulic equipment, also are contemplated.

The following examples further illustrate the invention but, of course, should not be construed as in any way limiting its scope.

### EXAMPLE 1

This example demonstrates clear-coated abrasion resistant hoses of the instant invention. Such high-pressure hoses were composed of linear low-density polyethylene, a combination of reinforcing materials (a first reinforcing material of polyester and a second reinforcing materials of an anodized steel fiber carriage braided sheath coated with brass), and an outer clear-coated jacket. The hoses were prepared by extruding the polyethylene through an annual die to form a core, coating the steel fiber with brass, placing adhesive on the core, weaving the core first with the polyester and then weaving again with the brass coated steel. Finally, a clear-coated jacket was applied and the jacket comprised PELLETHANE polyurethane elastomer commercially supplied by Dow Chemical.

Hoses were prepared with 5/16″ and ⅜″ diameters. In addition to clear hoses, colored hoses were also produced with translucent red, yellow, and black colors by using commercially available dyes in the clear-coated jacket polyurethane prior to its application.

The hoses were tested to be highly abrasion resistant and performed satisfactorily in application. In every instance, the metallic reinforcing layer was visible through the coating jacket. The hoses were easily inspected by visual means and confirmed the benefits of the claimed invention.

All pressures stated herein are gauge pressures.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An abrasion-resistant high pressure hose comprising:
(a) an inner core comprising a flexible material and defining a fluid-carrying conduit;
(b) a flexible reinforcing sheath covering said core, said sheath comprising a grid of interwoven strands of reinforcing fiber material disposed in surrounding relation to said core; and
(c) a clear-coated jacket covering said sheath, said jacket comprising an optically transparent or translucent polymeric material disposed in surrounding relation to said sheath such that the reinforcing sheath is visible though the jacket to a user from the outside of the hose.

2. The hose of claim 1 wherein said reinforcing sheath imparts a predetermined color to the hose.

3. The hose of claim 1 wherein the reinforcing sheath has a brass color.

4. The hose of claim 1 wherein the reinforcing fiber material is polymeric or metallic or any combination thereof.

5. The hose of claim 4 wherein the reinforcing fiber material is brass coated steel and said hose has a color of said brass coating.

6. The hose of claim 1 wherein the reinforcing fiber material comprises polymeric material and is dyed with a distinctive color and said hose a color of said dye.

7. The hose of claim 6 wherein the reinforcing fiber material is polyester.

8. The hose of claim 4 wherein the reinforcing fiber material is polyester and brass coated steel and said hose has a color of said brass coating.

9. The hose of claim 1 wherein the optically transparent or translucent polymeric material is selected from the group consisting of polyurethane, polyvinyl chloride, polyester, and combinations thereof.

10. The hose of claim 1 wherein the optically transparent or translucent polymer comprises a blend of polyurethane and polyvinyl chloride.

11. The hose of claim 1 further characterized wherein said clear-coated jacket is translucent and is colored red, blue, yellow, gray, black or any other distinctive color.

12. The hose of claim 1 wherein said inner core flexible material is selected from the group consisting of polyethylene, nylon, polyvinyl chloride, and combinations thereof.

13. The hose of claim 1 wherein said hose has a burst pressure of at least about 1000 psi and a kink-free minimum bend radius no greater either than about 38 mm or than about 10 times the radius of said hose, and wherein said minimum bend radius is determined by bending the hose with no fluid contained therein over an angle of 180° and by reducing the size of the bend to as small of diameter as possible without kinking the hose.

14. The hose of claim 13 wherein the minimum bend radius is no greater than about 38 mm.

15. The hose of claim 13 wherein the minimum bend radius is no greater than about 10 times the radius of said hose.

16. The hose of claim 13 wherein the burst pressure is at least about 4000 psi.

17. The hose of claim 16 wherein the burst pressure is at least about 8000 psi.

18. The hose of claim 17 wherein the burst pressure is at least about 14000 psi.

19. The hose of claims 1 or 13 wherein the reinforcing fiber material comprises metallic material and is characterized by having a braid angle of at least about 1.41.

20. A method of manufacturing a clear-coated abrasion-resistant high pressure hose comprising the steps of obtaining strands of reinforcing fiber material, optionally contacting said strands with at least one at least one coating material sufficient to impart a distinctive color, extruding a flexible material to form an inner core with an inner and outer surface, disposing an adhesive onto the outer surface of said core, braiding said strands into an interwoven grid surrounding said core to form a sheathed core, and applying a clear-coated jacket comprising an optically transparent or translucent polymeric material to form said clear-coated abrasion-resistant high pressure hose such that the reinforcing sheath is visible though the jacket to a user from the outside of the hose.

21. The method of claim 20 wherein the contacting step is performed and the coating material is a dye that imparts a predetermined color to the hose.

22. The method of claim 20 wherein the reinforcing fiber material is polymeric.

23. The method of claim 20 wherein the reinforcing fiber material is polyester.

24. The method of claim 20 wherein said inner core flexible material is selected from the group consisting of polyethylene, nylon, polyvinyl chloride, and combinations thereof.

25. The method of claim 20 wherein said extruding is through an annular die.

26. The method of claim 20 wherein the interwoven grid has a braid angle of at least about 1.41.

27. The method of claim 20 further comprising adding a dye to said optically transparent or translucent polymeric material to color it red, blue, yellow, gray, black or any other distinctive color.

28. The method of claim 20 wherein the reinforcing material is metallic.

29. The method of claim 28 wherein the coating material comprises brass and said hose has a color of said brass.

30. The method of claim 20 where the reinforcing material comprises a combination of metallic and polymeric materials.

31. The method of claim 20 wherein the braiding step comprises a first braiding step and a second braiding step.

32. The method of claim 31 wherein the first braiding step is performed with polyester and wherein the second braiding step is performed with brass coated metallic material to provide the hose with a brass color.

33. The method of claim 20 further comprising the step of recovering a hose characterized by having a burst pressure of at least about 1000 psi and a kink-free minimum bend radius no greater either than about 38 mm or than about 10 times the radius of said hose, and wherein said minimum bend radius is determined by bending the hose with no fluid contained therein over an angle of 180° and by reducing the size of the bend to as small of diameter as possible without kinking the hose.

34. A pressure washing apparatus comprising a source of pressurized water; an operator wand; and a clear-coated abrasion-resistant hose fluidically connecting said operating wand to said source, said hose comprising an inner core comprising a flexible material and defining a fluid-carrying conduit; a flexible reinforcing sheath covering said core, said sheath comprising a grid of interwoven strands of reinforcing fiber material disposed in surrounding relation to said core; a clear-coated jacket covering said sheath, said jacket comprising an optically transparent or translucent polymeric material disposed in surrounding relation to said sheath such that the reinforcing sheath is visible though the jacket to a user from the outside of the hose.

35. The pressure-washing apparatus of claim 34 wherein said hose is further characterized by having a burst pressure of at least about 1000 psi and a kink-free minimum bend radius no greater either than about 38 mm or than about 10 times the radius of said hose, and wherein said minimum bend radius is determined by bending the hose with no fluid contained therein over an angle of 180° and by reducing the size of the bend to as small of diameter as possible without kinking the hose.

36. The pressure-washing apparatus of claim 35 wherein the burst pressure is at least about 8000 psi.

37. The pressure-washing apparatus of claim 36 wherein the burst pressure is at least about 14000 psi.

38. The pressure washing apparatus of claim 34 wherein said hose is further characterized by having a minimum impulse value of at least about 30,000 cycles.

39. The pressure washing apparatus of claim 34 further characterized wherein said wand has a color and said hose has the same color.

40. The pressure washing apparatus of claim 34 wherein the color is red, blue, yellow, gray, black or any other distinctive color.
